(19) United States
(12) Patent Application Publication
(10) Pub. No.: US 2014/0188582 A1
(43) Pub. Date: Jul. 3, 2014

(54) SYSTEM AND METHOD FOR LOGGING WEBSITE INTERACTIONS

(71) Applicants: Steve Karson, Smyrna, GA (US); Michael John Burgiss, Marietta, GA (US); Brian Antonelli, Atlanta, GA (US); Chris Kulinski, Atlanta, GA (US)

(72) Inventors: Steve Karson, Smyrna, GA (US); Michael John Burgiss, Marietta, GA (US); Brian Antonelli, Atlanta, GA (US); Chris Kulinski, Atlanta, GA (US)

(21) Appl. No.: 13/758,339

(22) Filed: Feb. 4, 2013

Related U.S. Application Data
(60) Provisional application No. 61/746,885, filed on Dec. 28, 2012.

(51) Int. Cl. G06Q 30/02

(52) U.S. Cl. CPC G06Q 30/0263
USPC 705/14.6

(57) ABSTRACT

The present disclosure relates to computer-implemented systems and methods for logging website interactions. An example non-transitory computer-readable medium may have embodied thereon instructions executable by one or more processors. The instructions may cause the one or more processors to identify a page tag identifier associated with a web page received from a server. Additionally, the page tag identifier may be further associated with a user and a particular time the web page is received. The instructions may further cause the one or more processors to identify one or more advertisements associated with the web page, the one or more advertisements to be received from an advertisement server. Furthermore, the instructions may cause the one or more processors to associate one or more sub-tags with the one or more advertisements and associate the page tag identifier with the one or more sub-tags. The instructions may further cause the one or more processors to communicate one or more associations, between the page tag identifier and the one or more advertisements, to the advertisement server.

### TECHNICAL FIELD

The present disclosure generally relates to web pages, and in particular, to logging website user interactions and website events.

### BACKGROUND

With the advent of e-commerce, online businesses conduct vast amounts of transactions every day. As such, users are able to perform extensive online research using robust search engines before purchasing a product. With the increase in online research, additional opportunities for website advertisements arise. Both online businesses and those advertisers that advertise on the businesses' websites may be interested in determining, with regards to web content, what drives user activity on their websites.

### BRIEF DESCRIPTION OF THE DRAWINGS

Reference will now be made to the accompanying figures and diagrams, which are not necessarily drawn to scale, and wherein:

FIG. 1 shows a system for tracking user activity on websites according to one or more example embodiments.

FIG. 2 shows a tagging system for logging website interactions according to one or more example embodiments.

FIG. 3 shows a reporting system for logging website interactions, according to one or more example embodiments.

FIG. 4 shows a flow diagram of an example environment suitable for implementing methods for logging website interactions, according to one or more example embodiments.

FIG. 5 shows another flow diagram of an example environment suitable for implementing methods for logging website interactions, according to one or more example embodiments.

FIG. 6 shows yet another flow diagram of an example environment suitable for implementing methods for logging website interactions, according to one or more example embodiments.

FIG. 7 shows a user interface according to one or more example embodiments.

### DETAILED DESCRIPTION

In the following description, numerous specific details are set forth. However, it should be understood that embodiments of the present disclosure may be practiced without these specific details. In other instances, well-known methods, structures, and techniques have not been shown in detail in order not to obscure an understanding of this description. References to “one embodiment,” “an embodiment,” “example embodiment,” “various embodiments,” and so forth indicate that the embodiment(s) of the present disclosure so described may include a particular feature, structure, or characteristic, but not every embodiment necessarily includes the particular feature, structure, or characteristic. Furthermore, repeated use of the phrase “in one embodiment” does not necessarily refer to the same embodiment, although it may.

As used herein, unless otherwise specified, the use of the ordinal adjectives “first,” “second,” “third,” etc., to describe a common object merely indicates that different instances of like objects are being referred to and are not intended to imply that the objects so described must be in a given sequence, either temporally, spatially, in ranking, or in any other manner.

As used herein, unless otherwise specified, the term “user device” refers, in general, to an electronic communication device, both wired and wireless, and more particularly to one or more of the following: a portable electronic device, a telephone (e.g., cellular phone, smart phone), a computer (e.g., laptop computer, tablet computer, desktop computer, wearable computer), a portable media player, a personal digital assistant (PDA), or any other electronic device having a networked capability.

As used herein, unless otherwise specified, the term “server” may refer to any computing device having a networked connectivity and configured to provide one or more dedicated services to clients, such as a mobile device. The services may include storage of data or any kind of data processing. One example of the central server includes a web server hosting one or more web pages. Some examples of web pages may include social networking web pages. Another example of a server may be a cloud server that hosts web services for one or more computer devices.

As used herein, unless otherwise specified, the term “web page” may correspond to one or more web pages as part of one or more websites.

The present disclosure relates to computer-implemented systems and methods for logging website user interactions and website events. According to one or more embodiments of the disclosure, a non-transitory computer readable medium is provided. The non-transitory computer-readable medium may have embodied thereon instructions executable by one or more processors. The instructions may cause the one or more processors to identify a page tag identifier associated with a web page received from a server. Additionally, the page tag identifier may be further associated with a user and a particular time the web page is received. The instructions may further cause the one or more processors to identify one or more content elements, e.g., videos, images, articles, audio, advertisements and the like, associated with the web page, the one or more content elements to be received from a content server. Furthermore, the instructions may cause the one or more processors to associate one or more sub-tags with the one or more content elements and associate the page tag identifier with the one or more sub-tags. The instructions may further cause the one or more processors to communicate one or more associations, between the page tag identifier and the one or more content elements, to the content server.

According to one or more embodiments of the disclosure, a method is provided. The method may include receiving a page tag identifier associated with, for example and not limitation, a current web page, a user, a time the current web page was received, and a previous-page tag identifier. In addition, the method may include determining, using the previous-page tag identifier, a previous web page from which the user navigated to arrive at the current web page. Furthermore, the method may include analyzing one or more sub-tags associated with the previous-page tag identifier, wherein the one or more sub-tags indicate web page content associated with the previous web page. The method may also include identifying, based on the page tag identifier, the previous-page tag identifier, and the one or more sub-tags, particular web page content associated with the previous web page that motivated the user to navigate from the previous web page to the current web page.

According to one or more embodiments of the disclosure, a system is provided. The system may include a server to send instructions to a user device having one or more processors. As such, the instructions may cause the one or more processors to identify a page tag identifier associated with a web page received from a server. The page tag identifier may, for example, be associated with the web page, a user, and a particular time the web page is received. The instructions may further cause the one or more processors to identify one or more content elements associated with the web page, the one or more content elements to be received from a content server. Furthermore, the instructions may cause the one or more processors to associate one or more sub-tags with the one or more content elements and associate the page tag identifier with the one or more sub-tags. The instructions may further cause the one or more processors to communicate one or more associations, between the page tag identifier and the one or more content elements, to the content server.

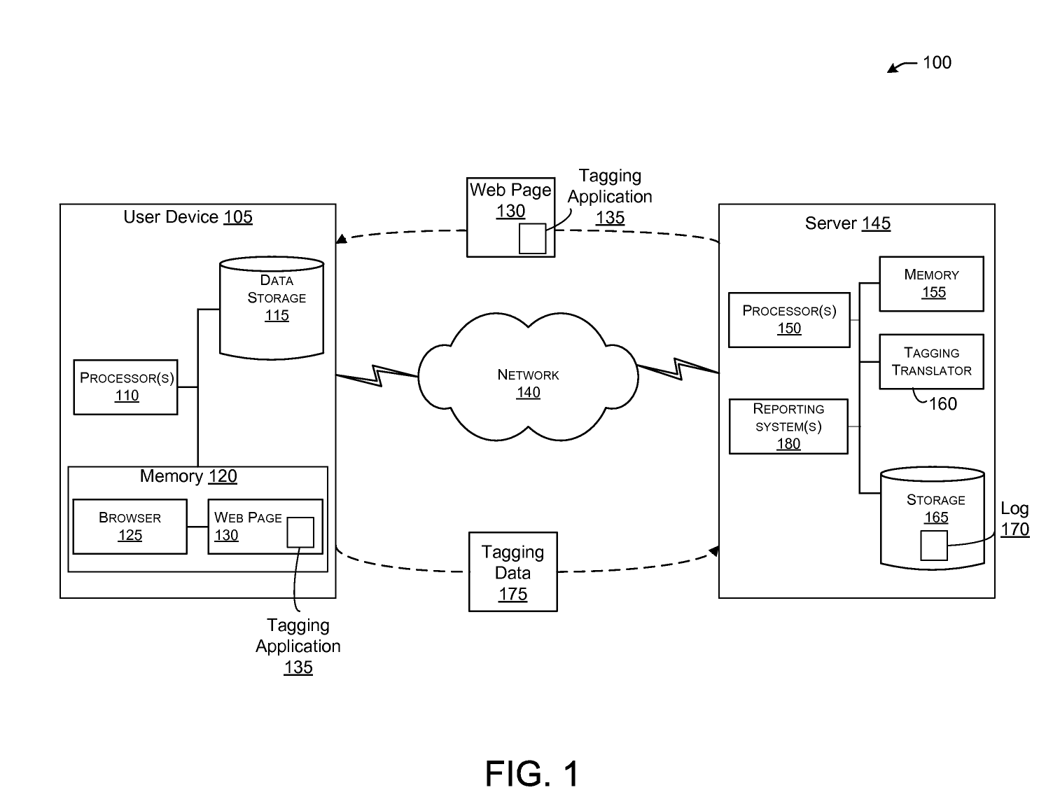

The above principles, as well as perhaps others, are now illustrated with reference to FIG. 1, which depicts a system 100 for logging website user interactions and website events. The system 100 may include a user device 105 in communication with a server 145 through a network 140. The network 140 may include any type of network including, but not limited to, local area networks (LAN), wide area networks (WAN), a Wi-Fi networks, ad-hoc networks, Bluetooth networks, near-field communication networks, telephone networks, cellular networks, radio networks, and/or any other type of wired or wireless network.

The user device 105 may include one or more processors 110 in communication with memory 120 and data storage 115. To this end, the memory 120 may be any type of memory including, but not limited to, random access memory, serial access memory, flash memory, read-only memory, cache memory, graphics memory, non-volatile memory, and/or any other type of persistent or non-persistent memory. Similarly, the data storage 115 may include any kind of storage devices, such as hard disk drives, solid-state drives, flash drives, tape drives, compact disc drives, DVD drives, Blu-Ray drive, network attached storage, remote storage locations and/or the like.

Additionally, the server 145 may also include one or more processor(s) 150. As depicted in FIG. 1, the processors 150 may be in communication with memory 155, storage 165, a tagging translator 160, and one or more reporting systems 180.

According to some embodiments, the user device 105 may be configured to receive one or more web pages 130 served by the server 145. For instance, a user of the user device 105 may navigate to a particular uniform resource locator (URL) address via a browser 125 stored in memory 120. As such, the URL address may correspond to the location of the web page 130, which may be stored on the server 145, such as in storage 165. Moreover, the web page 130 may be one of many web pages 130 hosted by the server and included within one or more websites. In some embodiments, the web pages 130 and/or website(s) hosted by the server 145 may be associated with web content related to vehicle commerce. For example, the web pages 130 (e.g., as part of one or more websites) may facilitate vehicle searching, advertising, buying, selling, trading, and/or other facets of vehicle commerce.

In addition, according to certain embodiments, the web page 130 may be associated with a tagging application 135. It should be noted that while FIG. 1 illustrates a web page 130 associated with a tagging application 135, in other embodiments, any number of web pages 130 may be associated with any number of tagging applications 135. To this end, the tagging application 135 may be configured to facilitate the tagging of certain web content and user activity associated with the web page 130. In other words, the tagging application 135 may be able to log user interaction with web page 130 as well as web content provided by the web page 130. For example, in some embodiments, the tagging application 135 may associate tags with advertisements, dynamic impressions, user clicks, and/or other content provided by the web page 130. Such tags may be described in more detail with reference to the figures described below.

Furthermore, in some embodiments, such tracking may facilitate determinations regarding what types of web content motivate a user to navigate from one web page 130 to another. For example, determining the motivations may enable discovering interests particular to the user, and such knowledge may be used to more effectively provide content that may match the user's interests. Moreover, such knowledge may also facilitate relatively more targeted advertisements associated with the user.

In some embodiments, the tagging application 135 may send tagging data 175 associated with the web page 130 back to the server 145. For instance, the tagging application 135 may first complete associating web content, provided by the web page 130, to corresponding tags before sending the tagging data 175 to the server 145. Alternatively, the tagging application 135 may provide the tagging data 175 dynamically and/or in real-time or near real-time as the tagging application 135 applies the appropriate tags. In some embodiments, the tagging application 135 may include JavaScript code. However, it should be understood that the tagging application 135 may include or may be written in any programming language. Additionally, in certain embodiments, the tagging application 135 may be written in an extensible language such that more or fewer tags may be defined on-the-fly depending on different implementations.

Furthermore, the server 145 may receive the tagging data 175 at the tagging translator 160 according to one or more embodiments. To this end, the tagging translator 160 may be configured to translate the tagging data 175 to a particular format that may be used to store information into a log 170. For example, in certain embodiments, the information stored in log 170 may be accessed by various other applications and systems (e.g., the reporting system 180) configured to process such information according to a particular format. Moreover, this particular format may facilitate relatively efficient storage of information to the log 170 (e.g., the particular format may employ certain compression algorithms to reduce file size). On the other hand, the tagging application 135 may convey the tagging data 175 to the server 145 in a different format. Thus, the tagging translator 160 may be configured to translate the data included in the format provided by the tagging application 135 to the particular format associated with storing information in the log 170. Furthermore, while FIG. 1 illustrates the log 170 as being stored in the server 145 using a storage 165, the log 170 may also be stored elsewhere, such as in a remote storage location or any other storage location.

According to some embodiments, the server 145 may also include a reporting system 180 to analyze tagging data 175 stored in the log 170. It should be noted that while the reporting system 180 is depicted as being included within the server 145, the reporting system 180 may be located elsewhere as well. For example, the reporting system 180 may represent its own separate system. In other implementations, the reporting system 180 may be included in one or more of the same systems as the tagging translator 160. To this end, the reporting system 180 may be configured to analyze the tagging data 175 recorded by the tagging application 135. Such analysis may be used to formulate reports and/or conclusions regarding certain aspects of such information. For example, the log 170 may store tagging data 175 corresponding to interactions of a particular user with one or more web pages 130 over a specified period of time. As such, the tagging data 175 may provide information related to the user's navigation across one or more web pages 130 as well as information related to web content provided by the one or more web pages 130.

In order to illustrate certain processes related to one or more embodiments of the system 100 more clearly, consider a scenario in which a user is presented with certain web content on an initial web page 130. For example, the user may be presented with images, links, and other web content related to a search for a Ford vehicle. The user may then decide to click on a link (e.g., a hyperlink) on the initial web page 130, thereby causing the user to navigate to a second web page. For instance, the user may click an image of a Ford Mustang, which may direct him to a second web page displaying the details associated with the Ford Mustang (e.g., Vehicle Identification Number, price, mileage, etc.).

During this process, the tagging application 135 may associate one or more tags with the web content provided by the respective web pages 130. As an example, the tagging application 135 may associate one or more tags with an image of the Ford Mustang on the initial web page 130. Furthermore, the tagging application 135 may also associate one or more tags with the user action of clicking on the link provided by the initial web page 130 (e.g., the image of the Ford Mustang may also include a hyperlink). Thus, tagging application 135 may record such tagging information with the tagging data 175, which may eventually be sent to the server 145 and stored in the log 170.

Continuing the above scenario, at some point, analysis of the tagging data 175 may be desired. Therefore, in some embodiments, the reporting system 180 may retrieve the tagging data 175 from the log 170 and provide analysis of the tagging data 175. For instance, the reporting system 180 may compile statistical information showing the type of web content that was presented to the user on the initial web page. By examining the tagging data 175, the reporting system 180 may also identify the link that the user clicked in order to navigate to the second web page (e.g., that the user clicked on an image of a Ford Mustang to navigate to a web page associated with details of the Ford Mustang). Additionally, the reporting system 180 may also determine the type and frequency of web content provided to the user on the second web page (e.g., the reporting system 180 may record how many times the user clicked on different Ford Mustang images and what kind of images, links, advertisements, etc. were present to the user after clicking the image). Thus, the reporting system 180 may provide a navigational map detailing the activities performed and web content experienced, by the user, in arriving at the current web page from the initial web page.

Additionally, in some embodiments, the server 145 may be a content server for providing a variety of content to the user. For example, the content server (server 145) may be an advertisement server for providing advertisements to the web pages 130. Alternatively, the advertisement server may be a separate server in communication with the server 145 and the user device 105. Regardless, the tagging application 135 may communicate, with the advertisement server, data related to certain tagging associations concerning advertisements presented to the user on the web pages 130. In addition to facilitating advertising, the content server may also be related to other content such as video media, image media, news feeds, stock information, and/or the like.

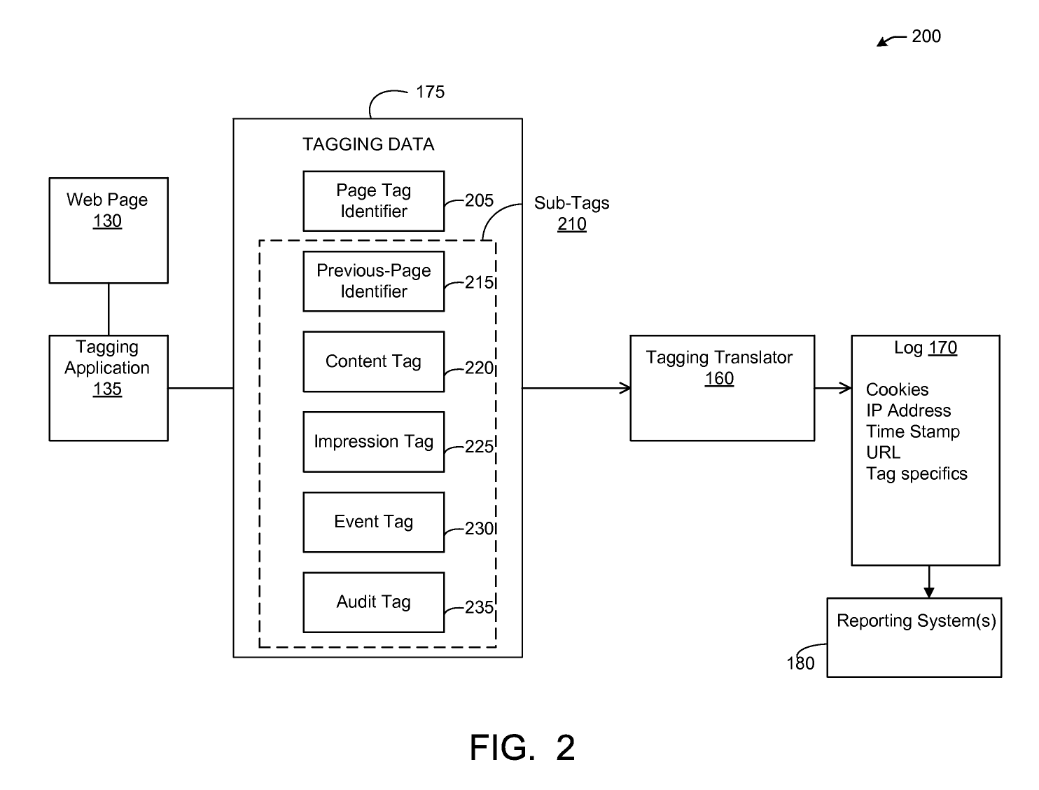

Turning now to FIG. 2, a framework 200 for tagging data to track user activity on websites is depicted according to one or more embodiments of the present disclosure. As discussed above, one or more web pages 130 may be served by the server 145 to the user device 105. The one or more web pages 130 may be associated with one or more tagging applications 135, which may track web content and user activity on the web page(s) 130 via tagging data 175. In some embodiments, the one or more web pages 130 may be attached with respective tagging application 135 when being sent from the server 145 to the user device 105. Thus, tagging of web page content on the web page 130 may in certain embodiments be performed on/by the user device 105. In some instances, performing tagging operations on the user device 105 may increase accuracy in tracking user activity when compared to performing such analysis on a server 145 since user activities may be tagged as activities are performed.

In some embodiments, the tagging data 175 may include a page tag identifier 205 and one or more sub-tags 210. The sub-tags 210 may include one or more of content tags 220, impression tags 225, event tags 230, and audit tags 235. Thus, one or more sub-tags 210 may also be respectively associated with the page-tag identifier 205. Moreover, in certain embodiments, the page tag identifier 205 may be unique for each distinct user, web page 130, and time combination. For example, if a user visits the same web page 130 but at different times, the tagging application 135 may associate a distinct page tag identifier 205 with the web page 130 for each instance the user navigated to the web page 130.

For instance, consider a scenario in which a web page 130 may be associated with a particular URL address. Furthermore, the web page 130 may represent a search results web page on which different results may be provided according search parameters input by the user from a previous web page. Under the scenario, each time a user performs a search, the user may be directed or navigated to the search results web page 130 identified by the particular URL address. As such, a user who conducts multiple searches may navigate to the search results web page 130 multiple times, even within the same session. To this end, the tagging application 135 may generate a different page tag identifier 205 corresponding to each instance the user navigates to the web page 130.

According to some implementations, the tagging data 175 may also include a previous-page tag identifier 215. In some embodiments, the previous-page tag identifier 215 may indicate a previous web page 130 from which the user navigated to arrive at the current web page 130 identified by the page tag identifier 205. For example, the previous-page tag identifier 215 may be a pointer to the previous web page. Alternatively, the previous-page tag identifier 215 may point to a page tag identifier 205 associated with the previous web page.

According to one or more embodiments, the sub-tags 210 may also include a content tag 220. In some instances, the content tag 220 may represent an advertisement tag 220 as well as other types of content tags 220. The advertisement tag 220 may be applied and/or generated when the web page 130 causes the browser 125 to make a request for an advertisement to be provided. As previously discussed, such a request may be made to the server 145 or to a separate advertisement server (not illustrated). In some embodiments, the advertisement tag 220 may include data identifying the particular advertisement that will be provided, such as a particular image(s), set of images, videos, and/or the like. It should be noted that references to the advertisement tag 220 are for exemplary purposes only and that other types of content tags 220 are also possible. For example, the content tag 220 may represent other types of non-advertisement content that may be served by a content server 145 to the user device 105.

Furthermore, in some embodiments, the sub-tags 210 may also include one or more impressions tags 225. In certain embodiments, the impression tags 225 may represent one or more dynamic impressions that may be associated with a particular web page 130 having a particular page tag identifier 205. Dynamic impressions may represent certain web content provided by a web page 130 that may change depending on circumstances surrounding the user and the web page 130. For example, search results, as described above, may change depending on the search parameters used to perform the search. However, the web page 130 used to display the search results may remain constant. Thus, the same web page 130 (i.e., the page represented by a constant URL address) may present different dynamic impressions to the user depending on the circumstances.

Additionally, dynamic impressions may also be present in contexts not limited to search results. To this end, dynamic impressions may include any type of web content in any context, such as text, images, tables, forms, and/or the like. For instance, consider a website for vehicle commerce in which multiple thumbnail images corresponding to different vehicles may be presented to a user. Clicking any of the thumbnail images may direct the user to a particular web page 130, identified by a certain constant URL address, regardless of which thumbnail image may be clicked.

However, the web content presented on the particular web page 130 may change depending on which thumbnail image is clicked. For example, by clicking on a thumbnail image of a BMW vehicle, a user may be directed to a detailed view of the BMW vehicle. The detailed view may include information related to the vehicle identification number, the year, the model, the make, the mileage, etc. Notably, with respect to the above example, both the thumbnail images and the detailed views corresponding to respective thumbnails may be considered dynamic impressions. Furthermore, as may be apparent, the detailed view of the thumbnail image may change depending on which thumbnail image the user clicks. For instance, clicking on a thumbnail image of a BMW vehicle may result in a different detailed view being presented than clicking on a thumbnail image of a Toyota vehicle. Thus, dynamic impressions may change though the web page 130 (and/or the URL address identifying the web page 130) may remain constant.

According to some embodiments, the sub-tags 210 may also include one or more event tags 230. The event tag 230 may be associated with direct and measureable user activity, such as user clicks. Thus, when a user performs clicks on links, dynamic impressions, advertisements, and/or the like, an event tag 230 may be generated and/or associated with the click. In other embodiments, one or more event tags 230 may also be generated to track when a user hovers his/her cursor over certain web content. For example, a user may hover the cursor over a particular dynamic impression, an advertisement, a link, and/or any other web content. Thus, the event tags 230 may also include data indicating the particular web content over which the user hovered and/or clicked. Moreover, the above examples with respect to the even tags 230 are merely illustrative, and other activities may also be associated with the even tags 230.

In some embodiments the sub-tags 210 may also include an audit tag 235 to keep track of whether the web page 130 associated with the page-tag identifier 205 is the first page provided to the user during a particular session. It should be noted that while FIG. 2 illustrates the tagging data 175 as having particular tags and sub-tags 210, in some embodiments, more or fewer of the tags and/or sub-tags 210 may be used. Furthermore, in some embodiments, one or more of the sub-tags 210 may also be linked with, or otherwise associated with one another. For example, an impression tag 225 may be associated with an event tag 230 to represent a scenario in which a user uses his/her cursor to hover over or click a dynamic impression associated with the impression tag 225.

In some embodiments, the tagging application 135 may be extensible. For instance, the tagging application 135 may be defined to record more or fewer tags and/or sub-tags 210 in the tagging data 175. Furthermore, the type of data with which the sub-tags 210 are associated may also be defined differently according to different implementations. For example, the tagging application 135 may be defined such that the impressions tag 225 is to be associated with sound and/or video content in addition to image content. Thus, the tagging application 135 may be relatively flexible in terms of performing tag and sub-tag 210 associations.

Additionally, in certain embodiments, the tagging application 135 may perform its functions automatically, manually, or a combination thereof. For instance, when a web page 130 is received by the browser 125, the tagging application 135 may automatically associate a page tag identifier 205 with the web page 130. However, with respect to the impression tag 225, the tagging application 135 may require manual input to define what type of web content on the web pages 130 should be associated with the impression tag 225.

According to one or more embodiments, the tagging data 175 may be sent to a tagging translator 160. As discussed above, the tagging translator 160 may translate the tagging data 175 to a particular format associated with storing information in the log 170. As such, the log 170 may store certain information in addition to recording tag specific data (such tag specific data may include, for example, the page tag identifier 205, the previous-page tag identifier 215, and sub-tags 210). For example, the log 170 may store information related to cookie sessions, Internet Protocol (IP) address of user device(s) 105, one or more timestamps associated with user navigation to the web page(s) 130, and/or URL addresses. It should be understood that the log 170 is not limited to storing the above listed data, and that the log 170 may be configured to store other types of data as well.

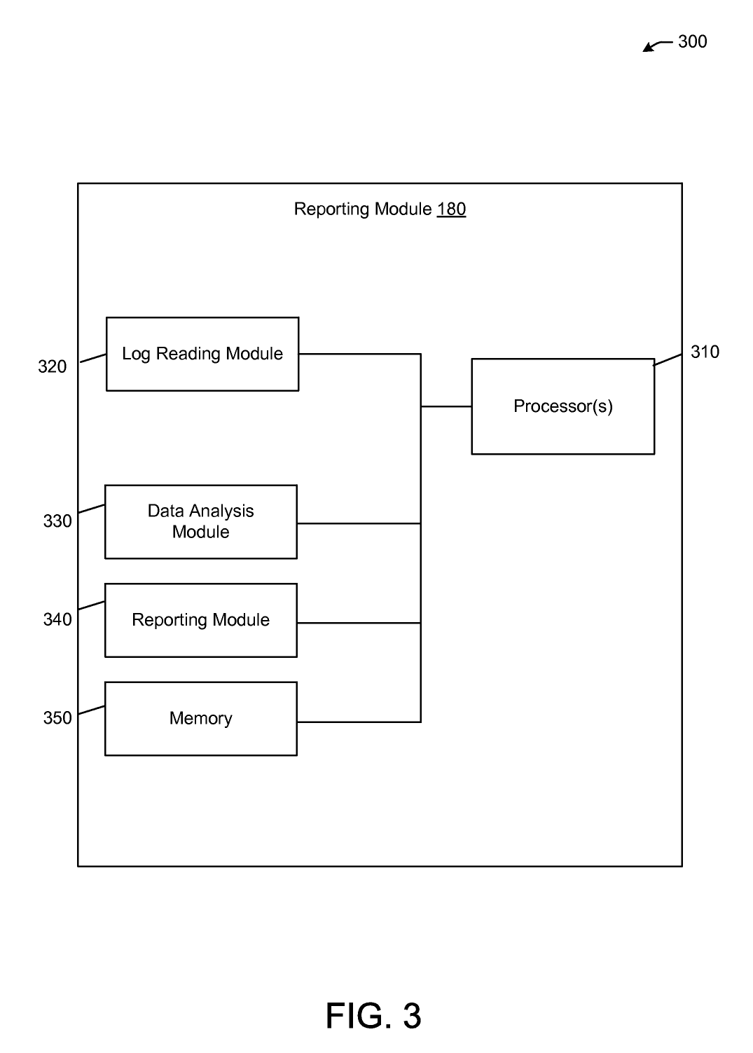

As previously mentioned, information stored in the log 170 (e.g., tagging data 175) may be later retrieved by the reporting system(s) 180, which will now be described with reference to FIG. 3, according certain embodiments. As illustrated in FIG. 3, the reporting system 180 may include one or more processor(s) 310 in communication with a log reading module 320, a data analysis module 330, a reporting module 340, and memory 350. In some implementations, the processor(s) 310 and memory 350 may correspond to the processor(s) 150 and memory 155 in the server 145. In other implementations, the reporting system may include its own processors 310 and memory 350.

In some embodiments, the log reading module 320 may be configured to retrieve the tagging data 175 from the log 170. In other implementations, the log reading module 320 may also be configured to translate the log 170 data into a format used by the reporting system 180. In addition, the log reading module 320 may retrieve tagging data 175 associated with multiple web pages 130 associated with multiple users. For example, in some embodiments, the log reading module 320 may retrieve tagging data 175 associated with all web pages 130 to which a user has navigated for a particular session. In other embodiments, the log reading module 320 may retrieve tagging data 175 associated with web pages 130 to which the user has navigated across multiple sessions. In yet other embodiments, such tagging data 175 may be associated with only a portion of the web pages 130 visited during a particular session. In still yet other embodiments, the log reading module 320 may retrieve tagging data 175 associated with multiple users navigating to multiple web pages 130. Furthermore, in certain embodiments, the log reading module 320 may retrieve tagging data 175 associated with a particular advertiser, such as particular advertisement tags 220 and other information from an advertisement server (e.g., server 145).

According to one or more embodiments, the data analysis module 330 may be configured to record and/or analyze certain information related to the tagging data 175 retrieved by the log reading module 320. For instance, the data analysis module 330 may be configured to compile statistical data related to the tagging data 175. Such statistical data may include the types and frequency of certain tags and/or sub-tags 210 associations. As another example, the data analysis module 330 may also analyze information concerning the frequency with which certain types of advertisement tags 220 are associated with certain web page(s) 130. It should be understood that the above examples are for illustrative purposes only, and that the data analysis module 330 may be configured to perform other types of analysis as well.

In certain embodiments, the reporting system 180 may also include a reporting module 340 to generate reports concerning analysis of the tagging data 175 performed by the data analysis module 330. For instance, the reporting module 340 may determine certain upward and/or downward trends that may be associated with certain tags and/or sub-tags 210. In another example, the reporting module 340 may be configured to provide recommendations, such as what type of dynamic impressions may be considered effective based on the number of event tags 230 associated with the dynamic impressions. That is, the reporting module may be configured to provide recommendations on which advertisements associated with which dynamic impressions are effective in driving events, e.g., clicks on those advertisements. It should be understood that the reporting module 340 is not limited by the above examples, and that it may be capable of creating other types of reports as well.

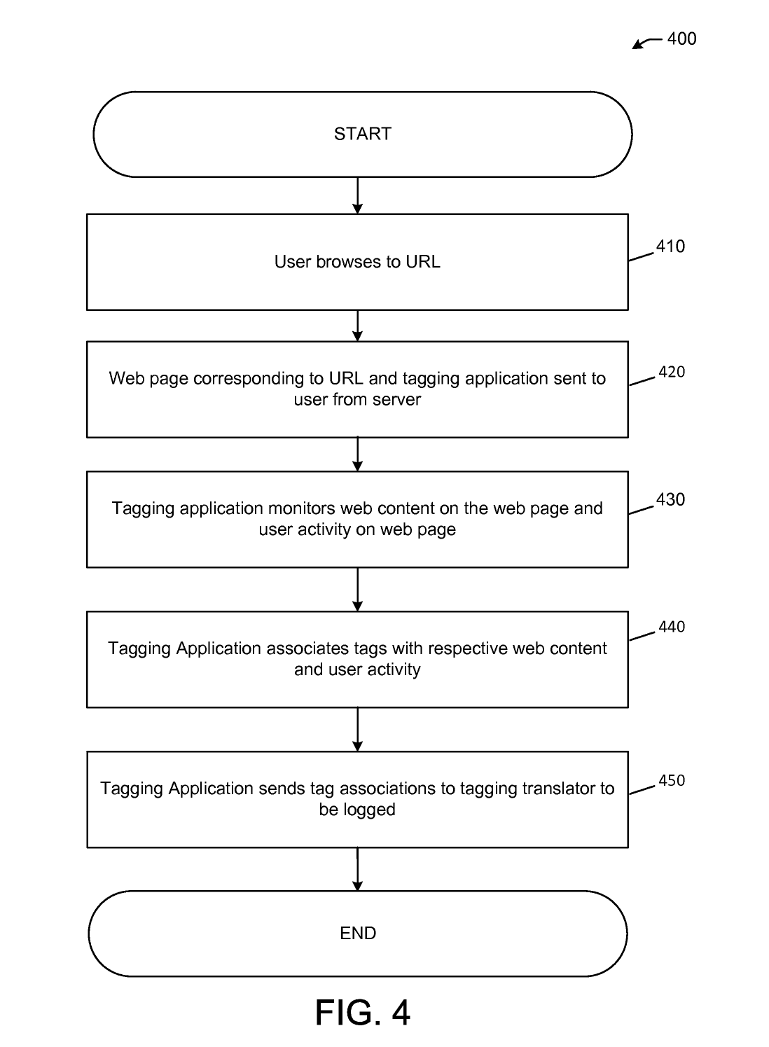

FIG. 4 represents a method 400 illustrating the operation of a tagging application for tracking user activity on websites according to one or more embodiments of the present disclosure. The method 400 may begin in block 410 in which a user, associated with a user device 105, may employ a browser (e.g., browser 125) to navigate to a particular URL address. In some embodiments, the URL address may identify a website related to vehicle commerce.

Then, in block 420, one or more web pages 130 corresponding to the URL address may be sent to the user from a server (e.g., server 145). Additionally, a tagging application 135 may also be sent to the user device. In some embodiments, the tagging application 135 may be linked or otherwise associated with the web page(s) 130, and therefore, the tagging application 135 and the web pages 130 may be sent to the user device 105 together.

In block 430, the tagging application 135 may monitor web content and user activity on the web pages 130 as the user continues to the browse the website. As such, the tagging application 135 may associate tags with respective web content and user activity. For example, the tagging application 135 may identify certain dynamic impressions, advertisements, and/or user clicks and generate respective tags and sub-tags 210 to be associated with the identified content. In addition, in some embodiments, for web pages 130 that are associated with particular users at particular times, the tagging application 135 may associate a distinct page tag identifier 205 with those web pages 130.

Thus, in certain embodiments, the tagging application 135 may perform its tagging operations on the user device 105. For example, enabling the tagging application 135 execute on the user device 105 may improve the accuracy of tagging capabilities (e.g., it may reduce false tags and ensure that tagged web content is actually seen by the user on the user device 105). For instance, some browsers 125 may include a tabbed-browsing feature in which the browser 125 may include multiple tabs associated with multiple different web pages. However, only a subset of the tabs may be viewed during a particular time frame. To this end, the tagging application 135, by executing on the user device 105, may be configured such that web content associated with a particular web page 130 in a particular tab may not be tagged until the particular tab is clicked or otherwise designated as the focus of the user. However, in other embodiments, the tagging application may be configured to execute on the server 145 as well.

In block 450, the tagging application 135 may send tag associations to a tagging translator 160 to be logged. For example, as discussed above with reference to FIG. 2, the tagging application 135 may send tagging data 175 to a tagging translator 160 in the server 145 to be stored in a log 170.

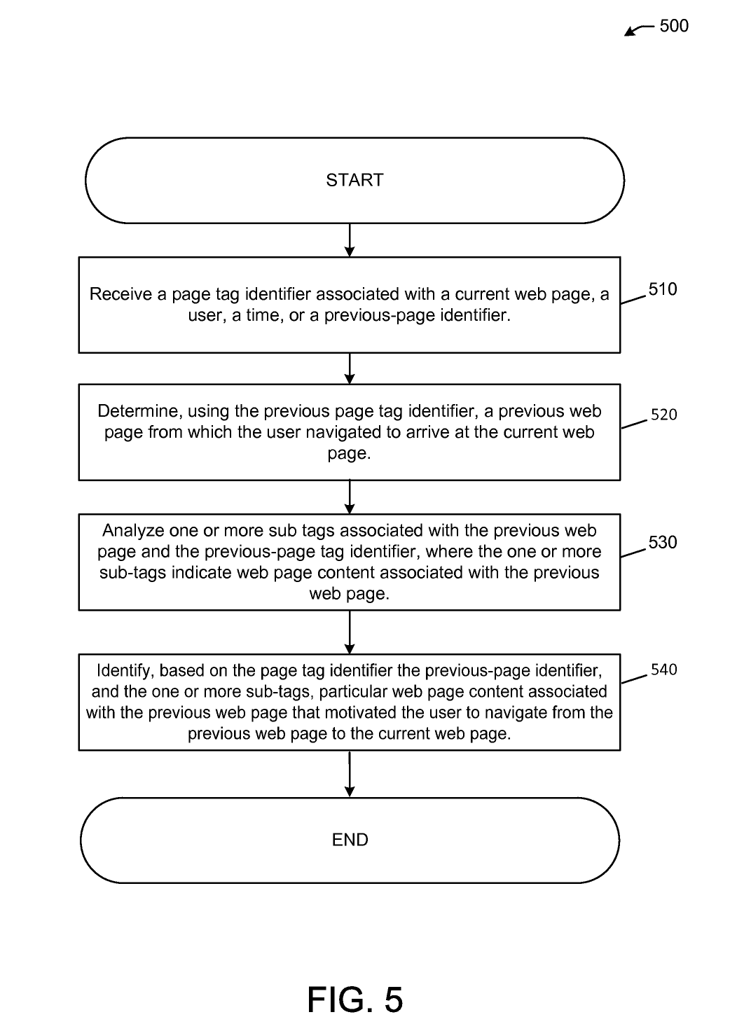

Turning now to FIG. 5, a method 500 is illustrated for tracking user activity on websites according to one or more embodiments of the present disclosure. The method 500 may begin in block 510, where a page tag identifier 205 associated with a current web page, a user, a time, and a previous-page tag identifier 215 may be received. In some embodiments, the page tag identifier 205 may be received at a server 145, such as by the reporting system 180.

In block 520, the server 145 (via the data analysis module 330 in the reporting system 180, for example) may determine, using the previous-page tag identifier 215, a previous web page from which the user navigated to arrive at the current web page. As previously discussed with respect to FIG. 2, the previous-page tag identifier 215 may indicate such a previous web page.

Thus, in block 530, the server 145 may analyze one or more sub-tags 210 associated with the web page 130 and the previous-page tag identifier 215. To this end, the one or more sub-tags 210 may indicate web content associated with the previous web page. Then, in block 540, the server 145 may identify, based on the page tag identifier, the previous-page tag identifier 215, and the one or more sub-tags 210, particular web page content associated with the previous web page that motivated the user to navigate from the previous web page to the current web page.

For example, in some embodiments, the reporting system 180 may receive tagging data 175 associated a current web page and a previous web page. Both web pages may be associated with respective page tag identifiers 205, sub-tags 210 and previous-page tag identifiers 215. To this end, the previous-page tag identifier 215 associated with the current web page may provide a link and/or an indication to the previous web page. In other words, the previous-page tag identifier 215 of the current web page may indicate that the user navigated from the previous web page (which is identified by the previous-page tag identifier 215) to the current web page.

Thus, according to one or more embodiments, the reporting system 180 in the server 145 may analyze the sub-tags 210 associated with the previous web page and pervious-page tag identifier 215. By examining these sub-tags 210, the reporting system 180 may identify certain web content that may have motivated the user to navigate from the previous web page to the current web page. For example, the reporting system 180 may identify that an impression tag 225 represents a thumbnail image of a certain vehicle (e.g., a BMW vehicle) as well as a hyperlink that leads to the current web page. Furthermore, the reporting system 180 may recognize that an event tag 230 representing a user click may be associated with the impression tag 225 (i.e., the thumbnail image). In other words, the user may have decided to click on the BMW vehicle thumbnail. Therefore, the reporting system 180 may identify the dynamic impression of the previous web page (e.g., the thumbnail image of the BMW vehicle) motivated the user to navigate from the previous web page to the current web page (e.g., to view further details regarding the BMW vehicle).

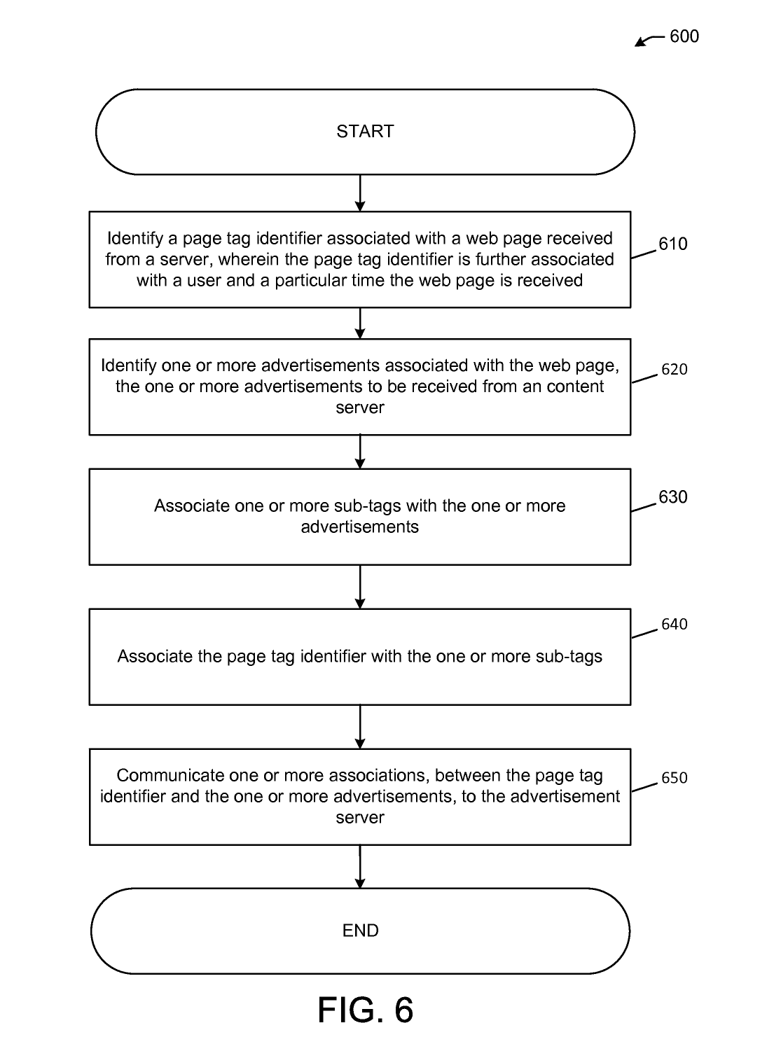

Turning now to FIG. 6, another method 600 is depicted for tracking user activity on websites according to one or more embodiments of the present disclosure. The method 600 may start in block 610 where a tagging application 135 may identify a page tag identifier 205 associated with a web page 130, which may be received from a server 145. In some embodiments, the page tag identifier 205 may be generated by the server 145. In other embodiments, the page tag identifier 205 may be generated by the tagging application 135. In yet other embodiments, the page tag identifier 205 may be generated by another device and/or application not shown.

In block 620, the tagging application 135 may identify one or more advertisements associated with the web page 130. To this end, the advertisements may be received from the advertisement server. As previously mentioned, the advertisement server may be included as part of the server 145 or as a separate server. For example, in some embodiments, the web page 130 may indicate to the browser 125 that advertisements from the advertisement server are to be presented at certain portions of the web page 130. Thus, the browser 125 may be configured to communicate with the advertisement server to retrieve the appropriate advertisements to be presented.

In block 630, the tagging application 135 may associate one or more sub-tags 210 with the one or advertisements. For instance, the tagging application 135 may associate one or more advertisement tags 220 with the advertisements to be recorded in the tagging data 175. In some embodiments, the tagging application 135 may identify requests to the advertisement server that the browser 125 may make in order to retrieve the advertisements for the web page 130. Therefore, whenever such a request is made, the tagging application may associate an advertisement tag 220 with the web page 130 to indicate that an advertisement is to be presented by the web page 130.

In block 640, the tagging application 135 may also associate the page tag identifier 205 with the one or more sub-tags 210. For example, the tagging application 135 may associated the advertisement tag(s) 220 with the page tag identifier 205. According to certain embodiments, such an association may indicate that the one or more advertisements, represented by the advertisement tag(s) 220, is associated with the web page 130 represented by the page tag identifier 205.

In block 650, the tagging application 135 may communicate one or more associations, between the page tag identifier 205 and the one or more advertisements, to the advertisement server. For example, the tagging application 135 may send the tagging data 175 (which may include the associations between the page tag identifier 205 and the advertisements) to the advertisement server. As such, the advertisement server may be aware that certain advertisements may be associated with certain page tag identifiers 205. Thus, in some embodiments, the reporting system 180 may be able to analyze advertisements from the advertisement server to make various determinations regarding advertisement and page tag identifier 205 associations. For example, the reporting system 180 may determine that certain types of vehicle advertisements have rarely been presented for a particular web page over a given period of time. As another example, the reporting system 180 may indicate that advertisements associated with a particular model of a vehicle have frequently been presented in response to certain search parameters. Thus, the reporting system 180 may be able facilitate determinations regarding the effectiveness of certain advertisements based on associations between page tag identifiers 205 and sub-tags 210 (e.g., advertisement tags 220). Furthermore, it should be noted that the examples described above are merely illustrative, and that the reporting system 180 may be configured to perform other analysis and/or determinations.

In other embodiments, the advertisement server may also send back information to the tagging application 135. Such information may include one or more indications as to the exact advertisements being presented to the user on the web page 135. For instance, when initially associating the one or more sub-tags 210 with the one or more advertisements, the tagging application 135 may only be aware that the browser 125 has made one or more requests to the advertisement server. In some instances, the tagging application may even be aware of the type of advertisement (e.g., whether it is for a vehicle other type of product). However, the information sent by the advertisement server may indicate the particular advertisement that will be presented, which in some instances, may be an indication related to a file location, file name, and/or other identifying characteristics of the particular advertisement.

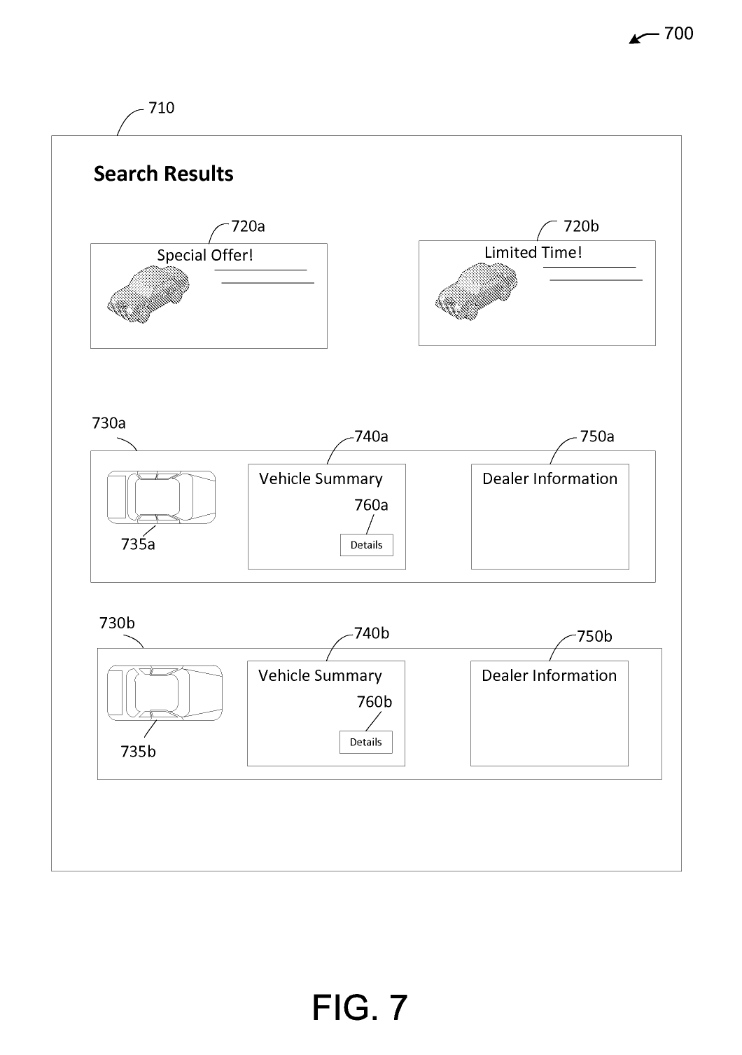

FIG. 7 represents a web page 700 associated with certain web content and tagging scheme 710 in accordance one or more embodiments of the present disclosure. The web page 700 may include various content such as advertisements 720a-b, vehicle search results 730a-b, images 735a-b, vehicle summary information 740a-b, details hyperlinks 760a-b, and dealer information 750a-b. It should be noted that the web content described above is merely illustrative and that other types and other combinations of web content are also possible. Furthermore, in some embodiments, the web page 700 may be representative of a search results page though other types of web pages are also contemplated.

Thus, in some embodiments, a tagging application 135 associated with the web page 700 may associate advertisements 720a-b with advertisement tags 220 and/or content tags 220. As previously explained, the tagging application 135 may communicate with an advertisement server (e.g., server 145) to exchange a page-tag identifier 205 and other information related to the advertisement(s) 720a-b.

According to one or more embodiments, the web page 700 may also include various vehicle search results 730a-b, which may change depending on search parameters. The vehicle search results 730a-b may be presented as respective frames including certain information associated with respective vehicles identified by the search results 730a-b. Thus, the tagging application 135 may associate the vehicle search results 730a-b with one or more impression tags 225.

According to certain embodiments, the vehicle images 735a-b may include certain images, such as thumbnail images, that illustrate a particular vehicle associated with the search results 730a-b. Vehicle summary information 740a-b may be presented in respective frames and may display information associated with respective vehicles. For example, such information may include VINs, make, model, year, mileage, etc. associated with respective vehicles. The respective vehicle summary information 740a-b frames may also include a details 760a-b hyperlink, which may provide a path to another web page displaying more detailed information associated with respective vehicles of the vehicle search results 730a-b. Additionally, the vehicle search results 730a-b may be associated with respective dealer information 750a-b. For example, dealer information 750a-b may present information associated with certain dealers that may be offering the respective vehicles for sale.

Accordingly, in some embodiments, all of the above information associated with respective vehicle search results 730a-b may be associated with one or more impression tags 225 by the tagging application 135. Furthermore, in some cases, any of the above content may also be associated with hyperlinks such that when a user clicks on particular content, the user may be directed to other web pages. As such, the tagging application 135 may associate one or more event tags 230 with particular content depending on user interaction with such content. For example, if a user clicks on the details hyperlink 760a, the tagging application 135 may associate one or more event tags 230 with the details hyperlink 760a. As another example, if the user were to hover a mouse cursor over vehicle image 730b, the tagging application 135 may associate one or more event tags with vehicle image 730b as well to indicate the hovering. Additionally, the tagging application 135 may associate the web page 700 with a page-tag identifier 205 as well as a previous-page identifier 215. For instance, the previous-page identifier 215 may indicate another web page in which a user inputted search parameters to arrive at the current search results web page 700.

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the present disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the present disclosure have been described in connection with what is presently considered to be the most practical and various embodiments, it is to be understood that the present disclosure is not to be limited to the disclosed embodiments, but is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present disclosure, including the best mode, and also to enable any person skilled in the art to practice certain embodiments of the present disclosure, including making and using any devices or systems and performing any incorporated methods. The patentable scope of certain embodiments of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A non-transitory computer readable medium storing instructions, that when executed by one or more processors, causes the one or more processors to:
identify a page tag identifier associated with a web page received from a server, wherein the page tag identifier is further associated with a user and a particular time the web page is received;
identify one or more advertisements associated with the web page, the one or more advertisements to be received from an advertisement server;
associate one or more sub-tags with the one or more advertisements;
associate the page tag identifier with the one or more sub-tags; and
communicate one or more associations, between the page tag identifier and the one or more advertisements, to the advertisement server.

2. The computer readable medium of claim 1, wherein the instructions further cause the processor to:
identify one or more dynamic impressions associated with the web page; and
associate the one or more sub-tags with the one or more dynamic impressions.

3. The computer readable medium of claim 1, wherein the instructions further cause the processor to:
identify one or more events associated with the web page; and
associate the one or more sub-tags with the one or more events.

4. The computer readable medium of claim 1, wherein the instructions further cause the processor to identify a particular image associated with the advertisement to be received from advertisement server.

5. The computer readable medium of claim 1, wherein the instructions further cause the processor to generate a different page tag identifier associated with the web page received from the server at a different time, wherein the web page is associated with the user.

6. The computer readable medium of claim 5, wherein the web page received at the different time is associated with one or more different dynamic impressions.

7. The computer readable medium of claim 1, wherein the instructions further cause the processor to store one or more associations between the page-tag identifier, the one or more sub-tags, and the one or more advertisements in a log.

8. A method, comprising:
receiving, at a server comprising at least one processor, a page tag identifier associated with a current web page, a user, a time the current web page was received, and a previous-page tag identifier;
determining, by the server, and using the previous-page tag identifier, a previous web page from which the user navigated to arrive at the current web page;
analyzing, by the server, one or more sub-tags associated with the previous-page tag identifier, wherein the one or more sub-tags indicate web page content associated with the previous web page; and
identifying, by the server, based on the page tag identifier, the previous-page tag identifier, and the one or more sub-tags, particular web page content associated with the previous web page associated with user navigation from the previous web page to the current web page.

9. The method of claim 8, wherein the one or more sub-tags indicate one or more dynamic impressions associated with the previous web page.

10. The method of claim 9, wherein the one or more dynamic impressions comprise information presented to the user based on one or more previous actions performed by the user.

11. The method of claim 8, wherein the one more sub-tags indicate one or more advertisements associated with the previous web page.

12. The method of claim 8, wherein the one or more sub-tags indicate one or more click events associated with the previous web page.

13. The method of claim 8, further comprising:
Analyzing, by the server, one or more current sub-tags associated with the current web page; and
identifying, by the server, based on the page tag identifier and the one or more current sub-tags, web page data provided to the user by the current web page, in response to the user navigation from the previous web page to the current web page.

14. The method of claim 8, further comprising receiving a different page tag identifier associated with the current web page, the user, and a different time at which the current web page was received.

15. A system comprising:
a server having a memory to store instructions, wherein the instructions cause one or more processors to:
identify a page tag identifier associated with a web page received from a server, wherein the page tag identifier is associated with the web page, a user, and a particular time the web page is received;
identify one or more advertisements, one or more dynamic impressions, and one or more events associated with the web page, the one or more advertisements to be received from an advertisement server;
associate one or more sub-tags with the one or more advertisements, the one or more dynamic impressions, and the one or more events;
associate the page tag identifier with the one or more sub-tags, and
store one or more associations between the page tag identifier and the one or more sub-tags in a log.

16. The system of claim 15, wherein the instructions further cause the one or more processors to communicate at least one association, between the page tag identifier and the one or more advertisements, to the advertisement server.

17. The system of claim 15, wherein the instructions further cause the one or more processors to identify a particular image associated with the advertisement to be received from advertisement server.

18. The system of claim 15, wherein the instructions further cause the one or more processors to generate a different page tag identifier associated with the web page received from the server at a different time, wherein the web page is associated with the user.

19. The system of claim 18, wherein the web page received at the different time is associated with one or more different dynamic impressions.

20. The system of claim 15, wherein the instructions further cause the one or more processors to generate a previous-page tag identifier associated with a previous web page from which the user navigated to arrive at the web page.
